(19) United States
(12) Patent Application Publication
(10) Pub. No.: US 2022/0143912 A1
(43) Pub. Date: May 12, 2022

(54) BUILD UNIT WITH A HEATER

(71) Applicant: Hewlett-Packard Development Company, L.P., Spring, TX (US)

(72) Inventors: Davinia Font Calafell, Sant Cugat del Valles (ES); Marc Borras Camarasa, Sant Cugat del Valles (ES); Julia Almacellas Visa, Sant Cugat del Valles (ES); Cristian Ferris Roig, Sant Cugat del Valles (ES); Pol Fornos Martinez, Sant Cugat del Valles (ES); Ismael Fernandez Aymerich, Sant Cugat del Valles (ES); Hector Vega Vega, Sant Cugat del Valles (ES)

(73) Assignee: Hewlett-Packard Development Company, L.P., Spring, TX (US)

(21) Appl. No.: 17/414,447

(22) PCT Filed: Aug. 2, 2019
(86) PCT No.: PCT/US2019/045014

§ 371 Date: Jun. 16, 2021

(51) Int. Cl. B29C 64/259; B29C 64/295; B29C 64/245; B33Y 30/00; B33Y 40/20

(52) U.S. Cl. CPC B29C 64/259; B29C 64/295; B33Y 40/20; B33Y 30/00; B29C 64/245

(57) ABSTRACT

A mobile build unit (2) for selectively locating in a build chamber (4) of an additive manufacturing machine (6). The mobile build unit has a build platform (8) to receive build material; and a build unit heater (10) to heat layers of build volume formed on the build platform (8). The build unit heater (10) is movable between a first position in which the build unit heater (10) is stored, and a second position in which the build unit heater (10) is mounted over the build platform (8).

### BACKGROUND

Additive manufacturing machines produce 3D objects by building up layers of material. Some additive manufacturing machines are commonly referred to as “3D printers”. 3D printers and other additive manufacturing machines make it possible to convert a CAD (computer aided design) model or other digital representation of an object into the physical object. The model data may be processed into slices each defining that part of a layer or layers of build material to be formed into the object. Build material may comprise any suitable form of build material, for example fibres, granules or powders. The build material can include thermoplastic materials, ceramic material and metallic materials.

### BRIEF DESCRIPTION OF THE DRAWINGS

Some non-limiting examples of the present disclosure will be described in the following with reference to the appended drawings in which:

FIG. 1 is a schematic perspective view of an additive manufacturing machine in accordance with an example;

FIG. 2 is a perspective view of a build unit of an additive manufacturing machine, in accordance with an example;

FIG. 3 is a perspective view of the build unit of FIG. 2, the build unit having a build unit heater mounted to cover a build platform of the build unit according to an example; and

FIG. 4 is a cross-sectional end view of the build unit heater of the build unit of FIG. 2 according to an example.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

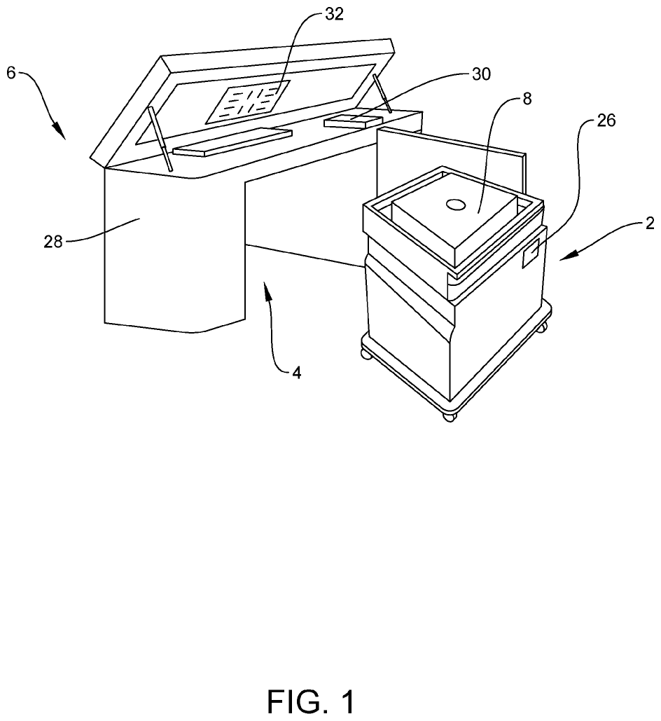

A 3D printing system is shown schematically in FIG. 1. The system has a build unit 2 and a printer 28, wherein the printer 28 has a build chamber 4, a printhead 30 movable across the build chamber 4, and a printer heater 32 to heat the build chamber 4. The build unit 2 is located in the build chamber 4 and is removable from the build chamber 4. The mobile build unit 2 has a build platform 8 to receive build material (not shown). The 3D printing system further has a build unit heater 10 to contact and heat build volume formed on the build platform 8 in use. The build unit heater 10 is movable between a first position in which the build unit heater 10 is stored, and a second position in which the build unit heater 10 is mounted to cover the build platform 8 and to contact and heat build volume formed on the build platform 8.

A schematic view of the mobile build unit 2 is shown in FIGS. 1, 2 and 3. The mobile build unit 2 is for selectively locating in the build chamber 4 of an additive manufacturing machine 6 (see FIG. 1).

The mobile build unit 2 is provided with the build unit heater 10 to heat layers of build volume formed on the build platform 8. The build unit heater 10 is movable between a first position in which the build unit heater is stored, and a second position (see FIG. 3) in which the build unit heater 10 is mounted over the build platform 8.

The build unit heater 10 is separable from the remainder of the mobile build unit 2. So, build unit heater 10 is stored either with the remainder of the mobile build unit 2 or at a location spaced from the remainder of the mobile build unit 2.

In different examples, the build unit heater is integral with the remainder of the mobile build unit. In some such examples, the build unit heater is movably connected to the remainder of the mobile build unit.

In the second position, the build unit heater 10 is mounted over the build platform 8 to locate the build unit heater 10, in use, adjacent build volume (not shown) formed on the build platform 8 to restrict air flow across a top surface of the build volume. More specifically, in the second position, the build unit heater 10 is mounted over the build platform 8 to locate the build unit heater 10, in use, in contact with a top surface of build volume formed on the build platform to prevent air flow across the top surface of the build volume.

In the second position, the build unit heater 10 is mounted on the build unit 2 to cover the whole of the build platform 8. In an example, the build unit heater is located in a lid and the lid is movable into a position where the lid is mounted on the build unit to cover the whole of the build platform. In an example, the lid is movably mounted to the remainder of the build unit.

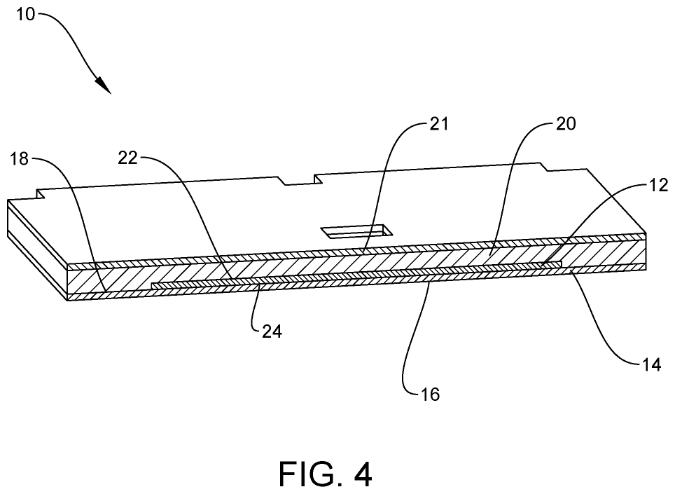

As shown in FIG. 4, the build unit heater 10 has a heating element 12 and a heat dissipater element 14.

The heat dissipater element 14 has a heat surface 16 on one side thereof which faces the build platform 8 and has a mounting surface 18 on an opposite side thereof. The heating element 12 is mounted to the mounting surface 18 of the heat dissipater element 14.

In one example, the heat dissipater element 14 is made of sheet metal.

In the example shown, the build unit heater 10 has a thermal insulating element 20 which is located on a side 22 of the heating element 12 opposite to the side 24 of the heating element 12 mounted to the heat dissipater element 14.

The mobile build unit 2 has a controller 26 to control the heating temperature of the build unit heater 10 during a period of time. The period of time will be between several minutes and several hours.

In a further example, the printer has the controller. In a yet further example, an external device separate from the printer and build unit has the controller.

The controller 26 varies the heating temperature with time depending on one or more factors. For example, a factor is the characteristic of the build volume, for instance a characteristic of the formed 3D object. In this way, the cooling process of the build volume (and therefore of the formed 3D object, or objects) can be controlled.

Specifically, the controller 26 reduces the heating temperature with time at a rate dependent upon one or more characteristics of the build volume. The characteristics of the build volume, on which control of the heating temperature depends, include the nature of the printed 3D object, for example the build material from which the 3D object is formed. So, in an example, the rate at which the build volume is allowed to cool by the build unit heater 10 will depend on the type of material from which the build is formed and the temperature or cooling profile (variation of material temperature with time) required to achieve a predetermined quality of the printed 3D object. Quality of the printed 3D object is a reference to characteristics such as dimensional accuracy and mechanical properties.

In another example, a factor affecting how the controller varies the heating temperature with time is the type of 3D print process used.

The way in which the controller varies temperature is determined either manually (by a user) or automatically, in either case depending on a defined requirement for characteristics of the printed 3D object. In one example, the way in which the controller varies temperature is determined automatically in response to the type of build material loaded in to the build unit.

In use of the additive manufacturing machine 6 shown in FIG. 1, a 3D object is formed by the printer 28 depositing successive layers of build material on to the build platform 8. The build unit 2, in which the build platform 8 is provided, controls a vertical movement of the build platform 8. Each new layer is built on top of the previous layer. During the additive manufacturing process, the build platform 8 moves downward step by step in defined increments corresponding to the layer thickness to give room for the next layer of build material.

The printhead 30 is mounted on a carriage (not shown), and the carriage is configured to move back and forth in one dimension across a plane parallel to and above the build platform 8. One pass of the printhead 30 moves the printhead 30 over the entire build platform 8. Layers of build material are formed on top of the build platform 8 and heated by printer heater 32.

After one material layer has been formed, the printhead 30 deposits a fusing agent in a pattern based on a cross-section of a layer of the object to be formed. Fusing energy is applied uniformly across the layer of build material. Those portions of the build material on which fusing agent has been applied absorb more fusing energy than those portions on which no fusing agent was applied and hence heat up more quickly, and fuse. After each layer is deposited and fused, the platform is lowered step-by-step, in increments corresponding to one layer advance.

When the 3D object formation process is complete, a mass of fused and unfused powder (“build volume” or “cake”) is present on the build platform 8. This volume of powder is post-processed (including being cooled in a controlled way) and for the unfused powder to be removed allowing recovery of the formed 3D object.

The build unit 2 is mounted on a wheeled trolley to be transported to the printer 28 and from the printer 28 to a post-processing station (not shown).

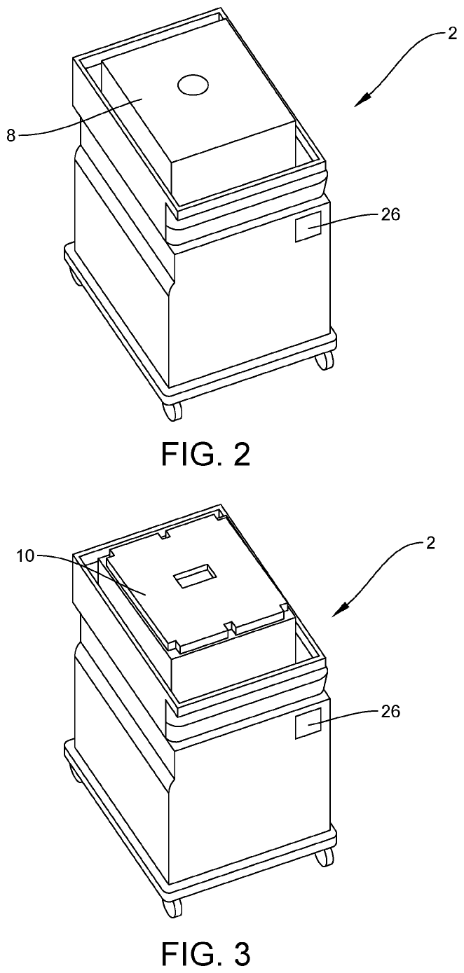

The build unit heater 10 is stored during the 3D printing process. The storage position is a position which does not interfere with the 3D printing process, for example a position in which the build unit heater 10 does not cover the build platform 8. As shown in FIG. 2, the build platform 8 is unobstructed by a build unit heater 10 and indeed the build unit heater 10 (not shown in FIG. 2) is separated and spaced from the build unit 2.

However, once the 3D printing process is complete and the cooling of the build volume is to be controlled, then the build unit heater 10 is moved to a position over the build volume (see FIG. 3). The build unit heater 10 is mounted to cover the build platform 8 before removing the build unit 2 from the build chamber 4. In the example shown in the accompanying drawings, this is achieved by opening the top cover of the printer 28. In this way, access to the platform 8 is provided while the build unit 2 remains in the printer 28 and without movement of the build unit 2 prior to the commencement of the controlled cooling process. This allows for minimal adverse impact to the powder and consequential quality of the part/object. The build unit 2 is moved from the build chamber 4 once the controlled cooling with the build unit heater 10 has begun.

In an example, prior to the build unit heater 10 being moved to cover the build platform, the build platform is moved downwards to lower the build volume. This provides space above the build volume and thereby allows the build unit heater 10 to be located above the build volume without increasing the overall height of the build unit and build volume combination, or without doing so to a significant extent. As a result, the build unit heater 10 does not interfere with removing the build unit from the printer or with locating the build unit in a post-processing station.

In the example shown in the drawings, the build unit heater 10 is connected to the build unit 2 for electrical connection to the controller 26 and to an electrical power source.

In a different example of use, the build unit 2 remains in the build chamber 4 until the controlled cooling with the build unit heater 10 has been completed. In a further example of use, the build unit 2 is removed from the build chamber 4 before the controlled cooling with the build unit heater 10 has begun. Once removed, the build unit heater 10 is then positioned on the build unit 2.

The build unit heater 10 is positioned on the build unit 2 to contact the top surface of the build volume. This reduces or avoids air currents (for example, convection air currents) contacting the top surface. Such air currents create unpredictable cooling and boundary layers on the build volume with are difficult to control. The build unit heater 10 allows for more controllable conductive heating of the top surface of the build volume, allowing for an appropriate cooling.

Even in an example where the build unit heater 10 is mounted over the build platform 8 but is not contacting the build volume, air flow over the top surface of the build volume can be reduced, for example, in the event that the build unit heater 10 has a seal with build unit 2 which forms a closed loop about the build platform 8.

Heaters (not shown) elsewhere in the build unit 2 are also used to heat the other surfaces of the build volume to allow for controlled cooling. Heaters in the printer 28 do not need to be used for this post-processing.

When the build unit 2 is removed from the build chamber 4, a second build unit (not shown) can be immediately (or at some stage thereafter) inserted into the build chamber 4 so that a further print process can begin while the build unit heater 10 is providing a controlled cooling of the build volume formed by the first build unit 2. Beginning a further print process in this way by using a second built unit, while the build volume from the previous print process is subjected to controlled cooling, allows the number of prints completed in a given period of time to be increased.

So, the present disclosure also refers to a method of heating a build volume formed by an additive manufacturing machine 6. The method moves a build unit 2 from a first position, in which the build unit 2 is located in a printer 28 having a printhead 30 to form a build volume in the build unit 2, to a second position, in which the build unit 2 is entirely removed from the printer 28. The method also moves a build unit heater 10 from a first position, in which the build unit heater 10 is stored, to a second position, in which the build unit heater 10 is mounted over the build platform 8. Furthermore, when the build unit 2 is in the second position thereof, the method operates the build unit heater 10 to heat layers of build volume formed in the build unit 2.

In the second position of the build unit heater 10, the build unit heater 10 is mounted over the build platform 8 to locate the build unit heater 10 in contact with a top surface of build formed on the build platform 8 to prevent air flow across the top surface of the build. The build unit 2 is moved from the first position to the second position thereof after the build unit heater 10 is moved from the first position to the second position thereof. The method also includes reducing the heating temperature with time at a rate dependent upon characteristics of the build.

In a different example, the build unit 2 is moved from the first position to the second position thereof prior to the build unit heater 10 being moved from the first position to the second position thereof.

When the build unit 2 is in the first position, located in a build chamber 4, the build unit heater 10 is electrically powered by way of an electrical connection to the build unit 2 which is itself powered by an electrically connected to the printer 28. The printer 28 is connected to a power supply (for example, an electric mains power supply). When the build unit 2 is in the second position, the build unit 2 is removed from the build chamber 4 and located in a chamber of a post-processing station (not shown). The build unit 2 is powered by an electrical connection to the post-processing station, and the build unit heater 10 is electrically powered by way of an electrical connection to the build unit 2. The post-processing station is connected to a power supply (for example, an electric mains power supply).

In a different example, the build unit heater 10 is powered independently of the printer 28 or post-processing station by way of an electrical connection directly with a power supply (for example, an electric mains power supply or a battery).

In addition, the present disclosure refers to a method of cooling a build volume formed by an additive manufacturing machine 6. The method moves a build platform 8 from a first position, in which the build platform 8 is located in a build chamber 4 having a printhead 30 associated therewith to form a build volume on the build platform 8, to a second position, in which the build platform 8 is entirely removed from the build chamber 4. The method also moves a heater from a first position, in which the heater is stored, to a second position, in which the heater is mounted over the build platform 8. Furthermore, when the build platform 8 is in the first position thereof, the method operates the heater to heat and to control the temperature of layers of build volume formed on the build platform 8. In this way, the heater is operated before movement of the build platform 8, which movement might adversely impact on build quality. Once controlled cooling with the heater has commenced, the build platform 8 is subsequently moved to the second position.

Build material may comprise any suitable form of build material, for example short fibres, granules or powders. A powder may include short fibres that may, for example, have been cut into short lengths from long strands or threads of material. The build material can include thermoplastic materials, ceramic material and metallic materials. In examples, fusing agent is used. In other examples, binding agent is used. Binding agents may include chemical binder, such as in Binder Jet or metal type 3D printing.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited by the claims and the equivalents thereof.

1. A mobile build unit for selectively locating in a build chamber of an additive manufacturing machine, the mobile build unit comprising:
a build platform to receive build material; and
a build unit heater to heat layers of build volume formed on the build platform, the build unit heater being movable between a first position in which the build unit heater is stored, and a second position in which the build unit heater is mounted over the build platform.

2. The mobile build unit of claim 1, wherein, in the second position, the build unit heater is mounted over the build platform to locate the build unit heater, in use, adjacent build volume formed on the build platform to restrict air flow across a top surface of the build volume.

3. The mobile build unit of claim 1, wherein, in the second position, the build unit heater is mounted over the build platform to locate the build unit heater, in use, in contact with a top surface of build volume formed on the build platform to prevent air flow across the top surface of the build volume.

4. The mobile build unit of claim 1, wherein, in the second position, the build unit heater is mounted on the build unit to cover the whole of the build platform.

5. The mobile build unit of claim 1, wherein the build unit heater comprises a heating element and a heat dissipater element, the heat dissipater element comprising a heat surface on one side thereof which faces the build platform and comprising a mounting surface on an opposite side thereof, the heating element being mounted to the mounting surface of the heat dissipater element.

6. The mobile build unit of claim 5, wherein the heat dissipater element is of sheet metal.

7. The mobile build unit of claim 5, wherein the build unit heater comprises a thermal insulating element which is located on a side of the heating element opposite to the side of the heating element mounted to the heat dissipater element.

8. The mobile build unit of claim 1, further comprising a controller to control the heating temperature of the build unit heater during a period of time.

9. The mobile build unit of claim 8, wherein the controller varies the heating temperature with time depending on characteristics of the build volume.

10. The mobile build unit of claim 9, wherein the controller reduces the heating temperature with time at a rate dependent upon characteristics of the build volume.

11. A method of heating a build volume formed by an additive manufacturing machine, the method comprising:
moving a build unit from a first position, in which the build unit is located in a printer having a printhead to form a build volume in the build unit, to a second position, in which the build unit is entirely removed from the printer;
moving a build unit heater from a first position, in which the build unit heater is stored, to a second position, in which the build unit heater is mounted over the build platform; and
when the build unit is in the second position thereof, operating the build unit heater to heat layers of build volume formed in the build unit.

12. The method of claim 11, wherein, in the second position of the build unit heater, the build unit heater is mounted over the build platform to locate the build unit heater in contact with a top surface of build volume formed on the build platform to prevent air flow across the top surface of the build volume.

13. The method of claim 11, wherein the build unit is moved from the first position to the second position thereof after the build unit heater is moved from the first position to the second position thereof.

14. The method of claim 11, wherein the method comprises reducing the heating temperature with time at a rate dependent upon characteristics of the build volume.

15. A method of cooling a build volume formed by an additive manufacturing machine, the method comprising:
moving a build platform from a first position, in which the build platform is located in a build chamber having a printhead associated therewith to form a build volume on the build platform, to a second position, in which the build platform is removed from the build chamber;
moving a heating element from a first position, in which the heating element is stored, to a second position, in which the heating element is mounted over the build platform; and
when the build platform is in the first position thereof, operating the heating element to heat and to control the temperature of layers of build volume formed on the build platform.
